(19) United States
(12) Patent Application Publication
(10) Pub. No.: US 2006/0265566 A1
(43) Pub. Date: Nov. 23, 2006

(54) Method and apparatus for verifying logical bindings between provisionable servers and provisionable storage array volumes

(76) Inventors: Sreerupa Sen, San Jose, CA (US); Pallavi Gadepalli, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/132,081

(22) Filed: May 17, 2005

(51) Int. Cl. G06F 12/00

(52) U.S. Cl. 711/170

(57) ABSTRACT

Embodiments of the invention provide methods and apparatuses for verifying logical bindings between provisionable resources and provisionable storage array volumes. In one embodiment, information that describes logical bindings between one or more provisionable servers and one or more storage array volumes in a system is accessed. A machine-readable network map that describes logical bindings between the one or more provisionable servers and the one or more storage array volumes in a system is accessed. The machine-readable network map is compared with the information. A report of the results from comparing of the machine-readable network map with the information is generated.

### RELATED APPLICATIONS

This Application is related to U.S. patent application Ser. No. 10/827,770 by David Graves, Parvathi Nair, Peggy Bertsch, filed on Apr. 19, 1004 and entitled “Method and Apparatus for Automatic Verification of Machine-Readable Map of Networked Devices” with attorney docket no. HP 10040488-1, assigned to the assignee of the present invention and incorporated herein by reference as background material.

### TECHNICAL FIELD

The present invention generally relates to network maps. More specifically to a system and method for automatically verifying logically bindings between provisionable servers and provisionable storage array volumes.

### BACKGROUND ART

In many large corporations, there are various user groups, such as human resources and billing, that use resources, such as computers and storage, to accomplish their assigned tasks. In the past, one way of providing the necessary storage and computer cycles was to hard wire a system so that each group had their own assigned computers and storage to accomplish their tasks. However, as time went on, it became evident that the various groups performed their tasks at different times and, therefore, did not need resources that were constantly assigned solely to particular groups. In other words, resources could be assigned to one group when that group needed the resources and then re-assigned to another group when the new group needed the resources. This led to the concept of “provisionable resources,” as will become more evident, that could be assigned to one group for a period of time and then re-assigned to another group for another period of time.

Resources that are currently assigned are commonly referred to as “provisioned resources.” Resources that are not currently assigned and resources that are assigned but capable of eventually being re-assigned are referred to as “provisionable resources.” Assigning and re-assigning resources is commonly referred to as “provisioning resources.” The term “assigning” shall refer to initially assigning resources as well as re-assigning resources. The “provisionable resources” that can be assigned to a group is commonly referred to as a “resource pool,” (also commonly known as a “farm”).

Since any combination of a set of servers and storage can be assigned to groups, “logical bindings” are used to track what servers and storage is currently provisioned to a group. For example, initially server A and storage D and E may be assigned to a human resources group. Therefore, there could be a logical binding between server A and storage D and another logical binding between server A and storage E.

As the servers and storage are re-assigned from group to group, the logical bindings between the servers and the storage change. Continuing the example, server B may be assigned to a billing group and storage D may be re-assigned from the human resources group to a billing group. Therefore, a new logical binding may be created between server B and storage D. Therefore, data that describes the logical bindings can become corrupted or become out of synch. Therefore, it may not be possible to provision a resource that is available for provisioning because the logical bindings indicate the resource is already provisioned. It can be difficult for a technician to determine where the problem is. Therefore, there is a need for a method and a system that helps technicians to determine what is wrong with logical bindings.

### DISCLOSURE OF THE INVENTION

Embodiments of the invention provide methods and apparatuses for verifying logical bindings between provisionable resources and provisionable storage array volumes. In one embodiment, information that describes logical bindings between one or more provisionable servers and one or more storage array volumes in a system is accessed. A machine-readable network map that describes logical bindings between the one or more provisionable servers and the one or more storage array volumes in a system is accessed. The machine-readable network map is compared with the information. A report of the results from comparing of the machine-readable network map with the information is generated.

### BRIEF DESCRIPTION OF THE DRAWINGS

The accompanying drawings, which are incorporated in and form a part of this application, illustrate embodiments of the present invention, and together with the description, serve to explain the principles of the invention. Unless noted, the drawings referred to this description should be understood as not being drawn to scale.

FIG. 1 is a block diagram of a system for verifying logical bindings between provisionable resources and storage array volumes, according to embodiments of the present invention.

FIG. 2 is a data flow diagram illustrating the flow of information between several elements depicted in FIG. 1 for verifying the logical bindings between provisionable resources and storage array volumes and generating a report of the results, according to embodiments of the present invention.

FIG. 3 depicts a flowchart for verifying logical bindings between provisionable resources and storage array volumes, according to embodiments of the present invention.

FIG. 4 is a block diagram depicting an apparatus for verifying logical bindings, according to embodiments of the present invention.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

Aspects of the present invention may be practiced on a computer system that includes, in general, a processor for processing information and instructions, random access (volatile) memory (RAM) for storing information and instructions, read-only (non-volatile) memory (ROM) for storing static information and instructions, a data storage device such as a magnetic or optical disk and disk drive for storing information and instructions, an optional user output device such as a display device (e.g., a monitor) for displaying information to the computer user, an optional user input device including alphanumeric and function keys (e.g., a keyboard) for communicating information and command selections to the processor, and an optional user input device such as a cursor control device (e.g., a mouse) for communicating user input information and command selections to the processor.

Overview of a System for Verifying Logical Bindings

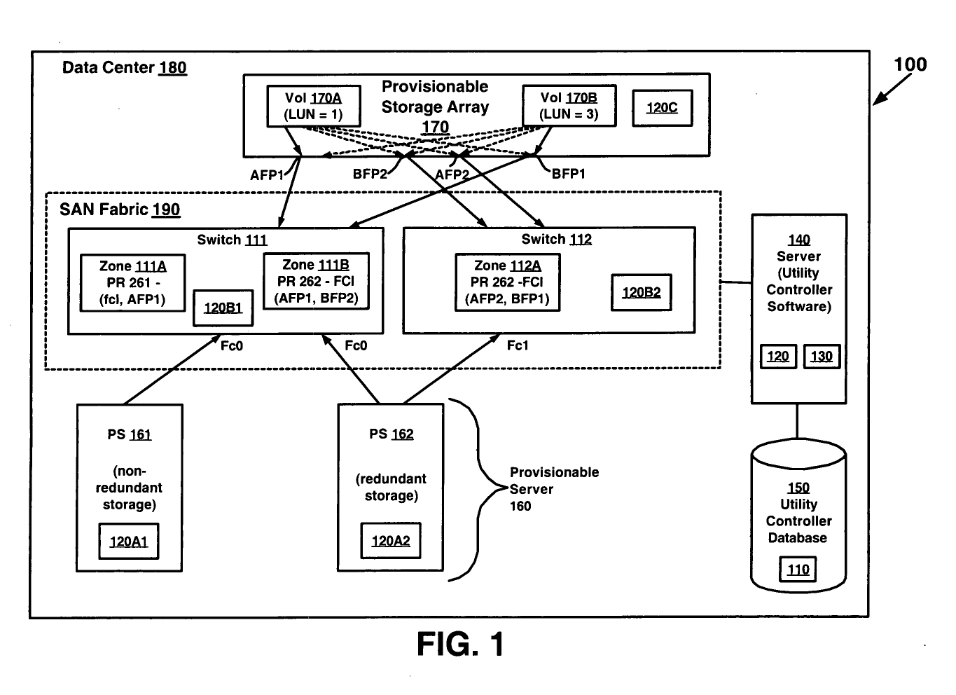

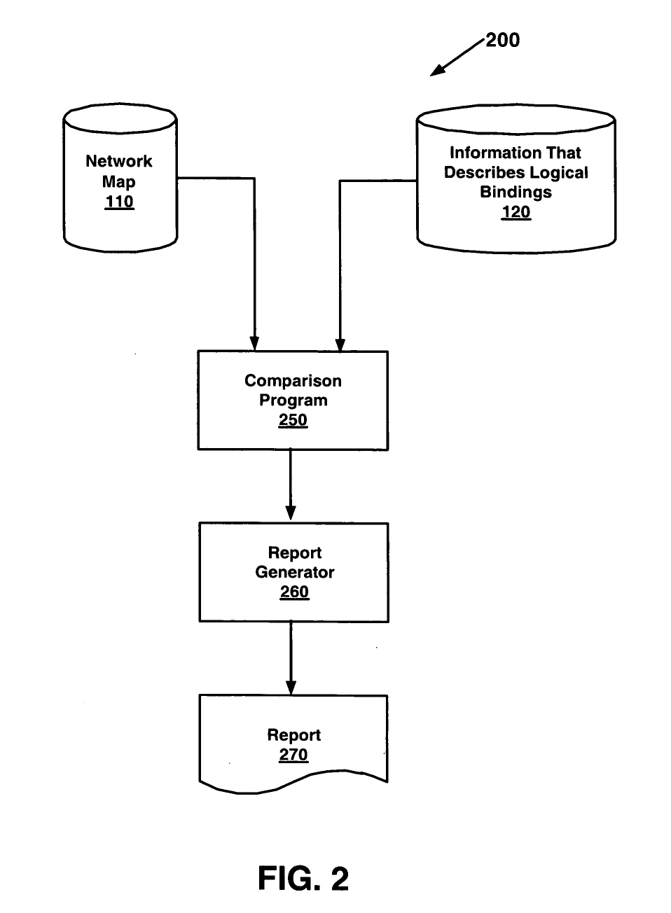

FIG. 1 is a block diagram of a system for verifying logical bindings between provisionable servers and provisionable storage array volumes, according to embodiments of the present invention. The blocks in FIG. 2 can be arranged differently than as illustrated, and can implement additional or fewer features than what are described herein. Further, the features represented by the blocks in FIG. 2 can be combined in various ways.

As depicted in FIG. 1, system 100 includes provisionable servers 161, 162 (e.g., 160), storage area network fabric 190, a provisionable storage array 170, utility controller software 140, and utility controller database 150. The SAN fabric 190 includes switches 111, 112, connections between the switches 111, 112 and the provisionable servers 160, as well as connections between the switches 111, 112 and the provisionable storage array 170. The utility controller software includes a comparison program 250, and a report generator 260. The utility controller database 150 includes a network map 110. The provisionable servers 160 and the provisionable storage array 170 are currently “provisioned” as depicted in FIG. 1.

The provisionable servers 160, the switches 111, 112, and the provisionable array 170 respectively include information that describes logical bindings 120A1, 120A2, 120B1, 120B2, 120C. Information 120 shall be used to refer to information 120A1, 120A2, 120B1, 120B2, and/or 120C.

The switches 111, 112 include zones 111A, 111B, 112A and the provisionable storage array 170 includes storage array volumes 170A, 170B. The storage array volumes 170A, 170B can be coupled to switches 111, 112 via storage array volume ports AFP1, BFP2, AFP2, BFP1. The switches 111, 112 can be communicatively coupled to provisionable servers 161, 162 (160) via ports FC0, FC1. According to another embodiment, switches 111, 112 can be fiber switches and ports FC0, FC1 can be provisionable server ports for the provisionable servers 160.

Provisionable Resources

Provisionable storage 170 and provisionable servers 160 are examples of provisionable resources. Provisionable servers 161, 162 can be resource servers that can be used for executing applications associated with user groups, according to one embodiment, or data servers, computational capability, load balancing servers, according to another embodiment, or any combination thereof, according to yet another embodiment.

According to one embodiment, additional provisionable resources can be added to a system 100 by adding more computer racks, for example, in the form of “pods.” Provisionable resources, such as servers 161, 162, switches 111, 112, and/or storage arrays 170, can be stored in computer racks, although this may not always be the case. As depicted in FIG. 1, the switches and computer systems are shown as being interconnected using cables or the like. However, wireless connections between devices 160, 111, 112, 170 are also contemplated.

According to one embodiment, storage arrays 170 can be disk arrays, Enterprise Virtual Arrays (EVAs), solid state devices (SSDs), Dynamic Access Memory (DRAM), Magnetic Random Access Memory (MRAM) or Flash, or any combination thereof.

Logical Bindings

There can be logical bindings between one or more provisionable servers 160 and one or more provisionable storage array volumes 170A, 170B, according to one embodiment. An example of a “logical binding” is a mapping from a provisionable server, such as provisionable server 161, to a provisionable server port, such as provisionable server port FC0, to a storage array volume port, such as storage array volume port AFP1, to a storage array volume, such as storage array volume 170A.

As already stated, a storage array 170 can be an EVA. For an EVA, each storage array volume 170A, 170B can be bound to a provisionable server 161, 162 which can be mapped to all of the storage array volume ports AFP1, BFP2, AFP2, BFP1 of the EVA, according to one embodiment. A provisionable server 160 may or may not have access to a storage array volume 170 via all of that storage array volume 170's storage array volume ports. For example, if a provisionable server, such as provisionable server 162, is in a resource pool that provides “storage redundancy,” then the provisionable server 162 can be bound to a storage array volume 170B via all of the storage array volume ports AFP1, AFP2, BFP1, BFP2, according to one embodiment. However, if a provisionable server, such as provisionable server 161, is in a resource pool that does not provide storage redundancy (e.g., non-redundant storage), then the provisionable server 161 can be bound to a storage array volume, such as storage array volume 170A, via only one storage array volume port AFP1, according to another embodiment.

According to one embodiment, zones 111A, 111B, 112A can be used as a part of creating logical bindings. For example, zone 111A indicates that provisionable server 161 is mapped to provisionable server port FC1 which is mapped to storage array volume port AFP1.

According to one embodiment, provisionable server ports FC0, FC1 are only mapped to storage array volume ports AFP1, AFP2, BFP1, BFP2 that are in the same zone 111A, 111B, 112B. According to another embodiment, a zone 111A that is associated with a provisionable server 161 that does not provide redundancy only associates a single storage array volume port AFP1 with the provisionable server 161. If a provisionable server 162, which provides redundancy, is bound to several storage array volumes 170A, 170B for a particular provisionable storage array 170, then all of those storage array volumes 170A, 170B could be accessed through the same storage array volume port (e.g., AFP1, AFP2, BFP1, or BFP2).

Logical Unit Numbers (LUNs) uniquely identify the storage array volumes 170A, 170B, according to one embodiment.

As depicted in FIG. 1, if provisionable server 161 is bound to storage array volume 170A and provisionable server 162 is bound to storage array volume 170B and given zones 111A, 111B, 112A, then the logical bindings, according to one embodiment, can be as depicted in Table 1 below:

TABLE 1
logical bindings that correspond to system 100

| | | | | Provisionable |
|---|---|---|---|---|
| Logical | Provisionable | Provisionable | Storage array | storage Array |
| Binding | server | server port | volume port | Volume |
| 1 | 161 | FC0 | AFP1 | 170A |
| 2 | 162 | FC0 | AFP1 | 170B |
| 3 | 162 | FC1 | AFP2 | 170B |
| 4 | 162 | FC1 | BFP1 | 170B |
| 5 | 162 | FC0 | BFP2 | 170B |

Information That Describes Logical Bindings

According to one embodiment, there is information that describes logical bindings 120 between the one or more provisionable servers 160 and the storage array volumes 170A, 170B. According to another embodiment, this information 120 can be obtained from provisionable servers 160, switches 111, 112, and/or provisionable storage arrays 170, among other things. For example, the information 120 can be obtained from drivers that are associated with the provisionable servers 160, switches 111, 112, and/or provisionable storage arrays 170.

According to one embodiment, information 120 that describes the logical bindings includes information describing whether the logical bindings involve provisionable servers 160 that provide storage redundancy (e.g., server 162) or do not provide redundancy (e.g., server 161). In the former case, the information can indicate the provisionable server 162 is bound to a storage array volume 170B through all of the storage array volume ports AFP1, AFP2, BFP1, BFP2, for example. In the later case, the information can indicate the provisionable server 161 is bound to a storage array volume 170A through one storage array volume port AFP1, for example.

Utility Controller Software

Utility controller software 140 can be communicatively coupled to the switches 111, 112, according to one embodiment. The utility controller software 140 resides on a server, according to another embodiment. The utility controller software 140 can store and maintain information 120 that describes logical bindings between the provisionable servers 160 and the storage array volumes 170A, 170B in a network map 110.

Network Map

It is noted that embodiments of the present invention can run in many different environments. One network management environment in which an embodiment operates serves as an end-to-end service management infrastructure and is particularly well suited to managing a provisionable network which can also be known as a utility data center 180 (UDC).

The network map 110 can be pre-loaded into a system 100, for example, by shipping the network map 110 with the servers 161, 172, the switches 111, 112 and/or the storage array 170, according to another embodiment, or can be created at an in-house data center 180, for example, at a customer's site, according to another embodiment. The network map 110 can be shipped to the customer site as a part of the utility controller database 150, according to one embodiment. In another embodiment, parts of the network map 110 are pre-loaded and parts are created at the customer's site, among other things. The network map 110 can be machine-readable.

Logical bindings can be dynamically created, for example, when servers are associated with farms and dynamically released when the servers are removed from farms, according to one embodiment. For example, each time a logical binding is created, the UC software 140 can load the logical binding into UCDB 150, for example, by loading it into the network map 110. Errors, which can lead to subsequent mismatches between the network map 110 and the information 120, can occur when a provisionable storage array 170 fails to create and/or release a logical binding, when a transient problem with database 150 occurs, or when the UC software 140 cannot update the database 150 properly, among other things.

As already stated, provisionable resources can be added to a system 100, for example by using “pods.” In the case of added provisionable resources, the network map 110 can be updated to describe logical bindings that result from the additional provisionable resources, according to another embodiment.

Differences Between the Information and the Network Map

The network map 110 and the information 120 should be in synch with each other, according to one embodiment. However, the network map 110 can become out of synch with the information 120, according to yet another embodiment as already described herein. For example, this out of synch situation can occur during periods when provisionable resources are frequently being assigned and re-assigned to the various user groups. More specifically, it may appear according to the network map 110 that a particular server 161, 162 is provisioned and therefore is logically bound to a particular storage array volume (170A or 170B) when in fact the server is not currently provisioned and therefore not bound to that storage array volume.

The fact that the network map 110 is at times out of synch with information 120 makes it difficult for information technology (IT) personal to configure and re-configure the servers 161, 162, the switches 111, 112, and/or the storage array volumes 170A, 170B so that various user groups, such as human resources, billing, etc, obtain the resources they need to perform their assigned tasks that require storage (e.g., storage array volumes 170A, 170B) and computer cycles from the servers 161, 162.

Dataflow Diagram

FIG. 2 is a data flow diagram illustrating the flow of information between several elements depicted in FIG. 1 for verifying the logical bindings between provisionable servers and provisionable storage array volumes and generating a report of the results, according to embodiments of the present invention. The data flow diagram 200 includes a network map 110, information that describes the logical bindings 120 as already described herein,a comparison program 250 that compares the network map 110 and the information that describes the logical bindings 120, a report generator 260, and a report 270.

The comparison program 250 accesses the network map 110 and the information that describes the logical bindings 120 and makes a comparison between them. Drivers associated with servers 161, 162, storage arrays 170 and/or switches 111, 112, among other things, can provide the information 120 in a form that the comparison program 250 can use, for example, by parsing information 120, according to one embodiment.

The report generator 260 receives the results of the comparison and generates a report 270. According to one embodiment, the report 270 is a human readable report. The report 270 can include messages describing as many “differences,” according to one embodiment, as well as “similarities,” according to another embodiment, between the network map 110 and the information 120 as the comparison program 250 finds. In reviewing the report 270, IT personal can determine that any one of the “differences” may reflect an error in either the network map 110 or the information 120 and act accordingly, according to another embodiment.

Network map 110 and the information 120 can be stored on separate storage devices, according to one embodiment, or on the same storage device, according to another embodiment. The comparison program 250 and report generator 260 can reside on the same computer, according to one embodiment, or on different computers, according to another embodiment, or a combination thereof. According to one embodiment, the comparison program 250 and/or the report generator 260 are a part of the utility controller software 140.

### OPERATIONAL EXAMPLE

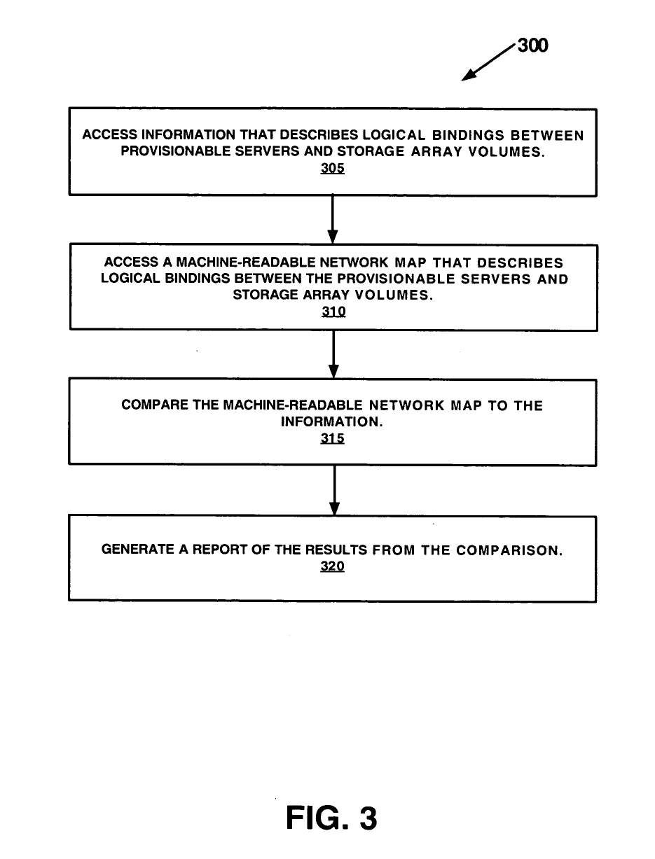

FIG. 3 depicts a flowchart 300 for verifying logical bindings between provisionable servers and provisionable storage array volumes, according to embodiments of the present invention. Although specific steps are disclosed in flowchart 300, such steps are exemplary. That is, embodiments of the present invention are well suited to performing various other steps or variations of the steps recited in flowchart 300. It is appreciated that the steps in flowchart 300 may be performed in an order different than presented, and that not all of the steps in flowchart 300 may be performed. All of, or a portion of, the embodiments described by flowchart 300 can be implemented using computer-readable and computer-executable instructions which reside, for example, in computer-readable media of a computer system or like device.

For the purposes of illustration, the following description of flowchart 300 shall refer to FIG. 1. Also for the purposes of illustration, assume that drivers on switches 111, 112, servers 160, and/or storage array 170 provide information 120. Further for the purposes of illustration, assume that the logical bindings are as depicted in Table 2 below:

TABLE 2
assume logical bindings

| Logical | Provisionable | Provisionable | Storage array | Storage |
|---|---|---|---|---|
| Binding | server | server port | volume port | Array Volume |
| 1 | 161 | FC0 | BFP1 | 170A |
| 2 | 162 | FC0 | AFP1 | 170B |
| 3 | 162 | FC1 | AFP2 | 170B |
| 4 | 162 | FC1 | BFP1 | 170B |
| 5 | 162 | FC0 | BFP2 | 170B |

Lastly, for the purposes of illustration, assume that information 120 (as depicted in Table 1) incorrectly describes logical binding 1 because information 120 indicates that the storage array volume port is BFP1 for logical binding 1 when in fact the storage array volume port for logical binding 1 should be AFP1. Further assume that logical bindings 2-5 are correctly described by information 120

In step 305, information that describes logical bindings between the provisionable servers and the provisionable storage array volumes is accessed, according to one embodiment. For example, the comparison program 250 can use view commands to access the information 120 to obtain information about the servers 161, 162, the storage array volumes 170A, 170B, the storage array volume ports AFP1, BFP2, AFP2, BFP1 that the storage array volumes 170A, 170B are bound to, and/or the switches 111, 112. Drivers associated with servers 161, 162, storage arrays 170, switches 111, 112 can provide the information 120 that comparison program 250 requested with the view commands in a form that the comparison program 250 can parse.

In step 310, a network map that describes logical bindings between the provisionable servers and the provisionable storage array volumes is accessed, according to one embodiment. For example, the comparison program 250 can access the network map 110 that is stored with the Utility Controller database 150 and determine what the logical bindings are according to the network map 110.

In step 315, the network map is compared with the information, according to one embodiment. For example, the comparison program 250 compares the network map 110 with the information 120. The comparison program 250 can compare each logical binding associated with the network map 110 with each of the logical bindings associated with information 120 to determine if there are any differences. According to this illustration, the comparison program 250 will determine that logical binding 1 associated with the network map 110 is out of synch with the information 120 and will determine that logical bindings 2-5 are in synch with information 120, for example.

In step 320, a report of the results from the comparison is generated, according to one embodiment. For example, the report generator 260 can generate messages describing any differences between network map 110 and information 120. More specifically, report 270 can include a message indicating that network map 110 and information 120 are different in regards to logical binding 1 (Table 2).

Similarly, the report generator 260 can generate messages when there is no difference between the information 120 and the network map 110. More specifically, report 270 can include messages indicating that network map 110 and information 120 are similar in regards to logical bindings 2-5 (Table 2).

The messages can contain the LUNs to indicate which logical binding the differences and/or similarities pertained to, according to one embodiment.

An Apparatus for Verifying Logical Bindings

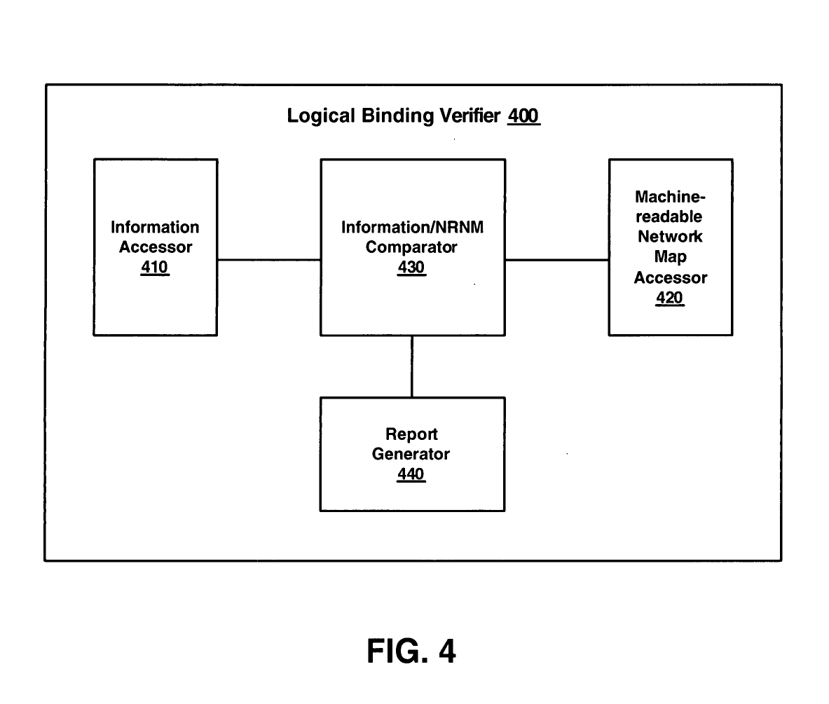

FIG. 4 is a block diagram depicting an apparatus 400 for verifying logical bindings, according to embodiments of the present invention. The blocks in FIG. 4 can be arranged differently than as illustrated, and can implement additional or fewer features than what are described herein. Further, the features represented by the blocks in FIG. 4 can be combined in various ways.

FIG. 4 depicts an apparatus called a logical binding verifier 400 that includes an information accessor 410 for accessing information 120 (305), a machine-readable network map accessor 420 for accessing a machine-readable network map 110 (310), an information/machine-readable network map comparator 430 for comparing the information 120 with the machine-readable network map 110 (315), and a report generator 440 for generating a report 270 (320), according to embodiments already described herein.

In summary, embodiments of the present invention provide methods and systems for automatic verification of a machine-readable map of networked devices. By using an automated process, correctness of a network map can be verified in much less time, at greatly reduced expense, and much more thoroughly than a visual inspection performed by a technician. Moreover, the process can be run repeatedly, at low expense, to allow early discovery of problems. In addition, the automated method not only reports each instance where the network map violates a rule, it also pinpoints the configuration error of the network map, decreasing search time as well as providing a report which may used by any network designer to fix the problem.

Embodiments of the present invention are thus described. While the present invention has been described in particular embodiments, it should be appreciated that the present invention should not be construed as limited by such embodiments, but rather construed according to the following claims.

We claim:

1. A method for verifying logical bindings between provisionable servers and provisionable storage array volumes, the method comprising:
accessing information that describes logical bindings between one or more provisionable servers and one or more storage array volumes in a system;
accessing a machine-readable network map that describes logical bindings between the one or more provisionable servers and the one or more storage array volumes in a system;
comparing the machine-readable network map with the information; and
generating a report of the results from the comparing of the machine-readable network map with the information.

2. The method as recited in claim 1, wherein the accessing the machine-readable network map that describes the logical bindings further comprises:
accessing the machine-readable network map that describes at least one mapping from a provisionable server port to a storage array volume port to a storage array volume.

3. The method as recited in claim 1, wherein the generating the report of the results further comprises:
generating a report that reports the Logical Unit Numbers (LUN) that uniquely identify the one or more storage array volumes.

4. The method as recited in claim 1, wherein the method further comprises:
selecting the machine-readable network map from a group consisting of a text file and a database.

5. The method as recited in claim 1, wherein the accessing a machine-readable network map further comprises:
accessing the machine-readable network map from a Utility Controller database (UCDB).

6. The method as recited in claim 1, further comprising:
adding additional provisionable resources to the system; and
wherein accessing the information that describes the logical bindings further comprises accessing information that describes logical bindings associated with the additional provisionable resources.

7. The method as recited in claim 1, wherein the accessing the information that describes logical bindings further comprises:
accessing information that is associated an entity selected from a group consisting of one or more switches, the one or more storage arrays, and one or more provisionable servers.

8. The method as recited in claim 1, wherein the generating a report of the results further comprises:
generating a report that is human-readable.

9. An apparatus for verifying logical bindings between provisionable servers and provisionable storage array volumes comprises:
an information accessor for accessing information that describes logical bindings between one or more provisionable servers and one or more storage array volumes in a system;
a machine-readable network map accessor for accessing a machine-readable network map that describes logical bindings between the one or more provisionable servers and the one or more storage array volumes in a system;
a comparator for comparing the machine-readable network map with the information; and
a report generator for generating a report of the results from the comparing of the machine-readable network map with the information.

10. The apparatus of claim 9, wherein the information/machine-readable network map comparator resides on the same device that a utility controller software executes on.

11. The apparatus of claim 9, wherein the machine-readable network map is associated with a utility controller database (UCDB).

12. The apparatus of claim 9, wherein the information is associated with an entity selected from a group consisting of one or more switches, the one or more storage arrays, and one or more servers.

13. The apparatus of claim 12, wherein a switch is a Fiber switch.

14. The apparatus of claim 9, wherein a provisionable server is selected from a group consisting of a resource server, a data server, a computational capability server, and a load balancing server.

15. The apparatus of claim 9, wherein a storage array is selected from a group consisting of a disk array, a Enterprise Virtual Array (EVA), a solid state device (SSD), Dynamic Random Access Memory (DRAM), Magnetic Random Access Memory (MRAM), and Flash.

16. A computer-readable medium having computer-readable program code embodied therein for causing a computer system to perform a method of verifying logical bindings between provisionable resources and storage array volumes, the method comprising:
accessing information that describes logical bindings between one or more provisionable servers and one or more storage array volumes in a system;
accessing a machine-readable network map that describes logical bindings between the one or more provisionable servers and the one or more storage array volumes in a system;
comparing the machine-readable network map with the information; and
generating a report of the results from the comparing of the machine-readable network map with the information.

17. The computer-readable medium as recited in claim 16, wherein the computer-readable program code embodied therein causes a computer system to perform the method and wherein the accessing the machine-readable network map that describes the logical bindings further comprises:
accessing the machine-readable network map that describes at least one mapping from a provisionable server port to a storage array volume port to a storage array volume.

18. The computer-readable medium as recited in claim 16, wherein the computer-readable program code embodied therein causes a computer system to perform the method and wherein the generating the report of the results further comprises:
generating a report that reports the Logical Unit Numbers (LUN) that uniquely identify the one or more storage array volumes.

19. The computer-readable medium as recited in claim 16, wherein the computer-readable program code embodied therein causes a computer system to perform the method and wherein the method further comprises:
selecting the machine-readable network map from a group consisting of a text file and a database.

20. The computer-readable medium as recited in claim 16, wherein the computer-readable program code embodied therein causes a computer system to perform the method and wherein the accessing a machine-readable network map further comprises:
accessing the machine-readable network map from a Utility Controller database (UCDB).

21. The computer-readable medium as recited in claim 16, wherein the computer-readable program code embodied therein causes a computer system to perform the method and wherein the method further comprises:
adding additional provisionable resources to the system; and
wherein accessing the information further comprises accessing information that describes logical bindings associated with the additional provisionable resources.

22. The computer-readable medium as recited in claim 16, wherein the computer-readable program code embodied therein causes a computer system to perform the method and wherein the accessing the information further comprises:
accessing information that is associated with an entity that is selected from a group consisting of one or more switches, the one or more storage arrays, and one or more servers.

23. The computer-readable medium as recited in claim 16, wherein the computer-readable program code embodied therein causes a computer system to perform the method and wherein the generating a report of the results further comprises:
generating a report that is human-readable.

24. A data center comprising:
a plurality of devices; and
a plurality of logical bindings that bind the plurality of devices, wherein a comparison program compares a machine-readable network map associated with a utility controller and information associated with entities selected from a group consisting of a server, a switch, and a storage array, wherein the machine-readable network map and the information describe logical bindings between the devices.
